(19) United States
(12) Patent Application Publication
(10) Pub. No.: US 2011/0102373 A1
(43) Pub. Date: May 5, 2011

(54) OPTICAL PEN AND OPTICAL TOUCH DEVICE HAVING SAME

(75) Inventors: CHIA-CHUN CHANG, Tu-Cheng (TW); HUNG-LUNG HO, Tu-Cheng (TW)

(73) Assignee: HON HAI PRECISION INDUSTRY CO., LTD., Tu-Cheng (TW)

(21) Appl. No.: 12/691,098

(22) Filed: Jan. 21, 2010

(30) Foreign Application Priority Data
Nov. 4, 2009 (CN) 200910309280.3

(51) Int. Cl. G06F 3/042; G09G 3/28

(52) U.S. Cl. 345/175; 345/182

(57) ABSTRACT

An exemplary optical pen includes a body, an infrared light source received in the body, a converging lens unit, and a tip. The converging lens unit is received in the body and is positioned along the light path of infrared light emitted from the infrared light source, and is configured for converging the infrared light. The tip includes a receiving end and a handwriting end at opposite sides thereof and defines a through hole extending from the receiving end to the handwriting end. The receiving end is received in the body and is configured for fixing the converging lens unit. The handwriting end protrudes from the body and is configured for projecting the converged infrared light.

### BACKGROUND

1. Technical Field

The present disclosure relates to optical pens and optical touch devices having the same.

2. Description of Related Art

An optical touch device has been proposed recently. The optical touch device includes an optical pen for projecting an infrared light spot onto an object and an infrared camera module for capturing images of a movement track of the infrared light spot. The captured images of the movement track of the infrared light spot can be processed and used for some applications, such as for inputting information.

Therefore, an optical pen and an optical touch device having the same are needed.

### BRIEF DESCRIPTION OF THE DRAWINGS

FIG. 1 is an isometric and schematic view of an optical pen, according to a first exemplary embodiment.

FIG. 2 is a partial and sectional view of the optical pen of FIG. 1.

FIG. 3 is an isometric and schematic view of an optical touch device, according to a second exemplary embodiment.

FIG. 4 is an isometric and schematic view of an optical touch device, according to a third exemplary embodiment.

### DETAILED DESCRIPTION

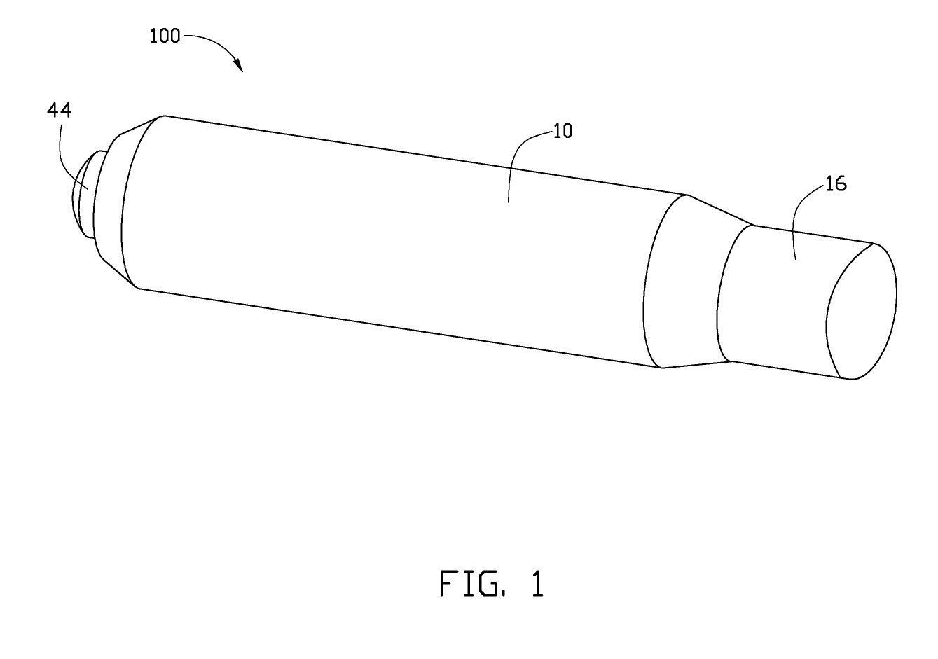

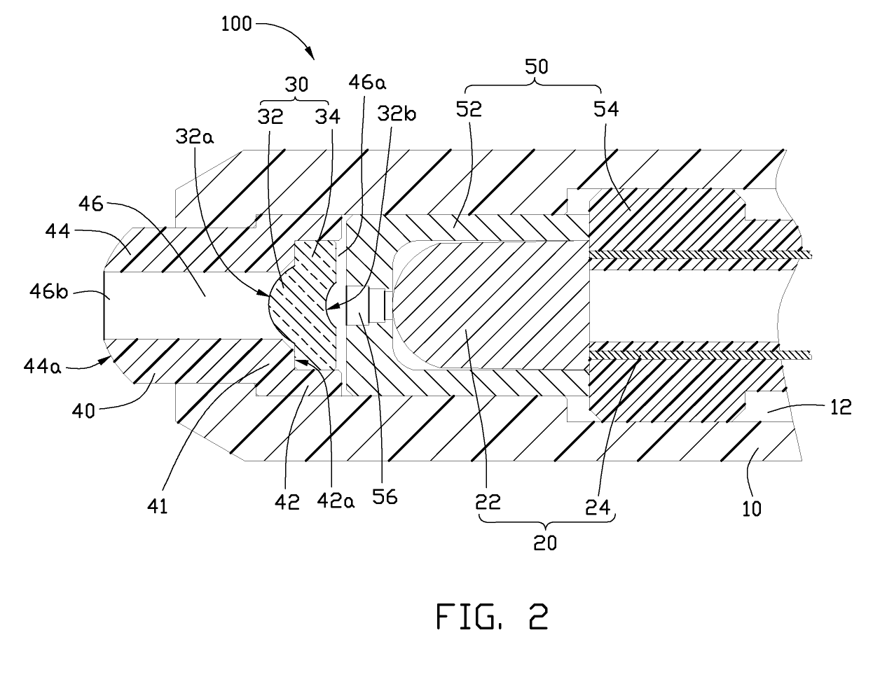

Referring to FIGS. 1 and 2, an optical pen 100, according to a first exemplary embodiment, includes a body 10, an infrared light source 20, a converging lens unit 30, a tip 40, and a fixing member 50.

The body 10 is substantially a hollow cylinder and defines a receiving space 12. The receiving space 12 is configured for receiving the infrared light source 20 and the converging lens unit 30. A material of the body 10 may be metal or plastic.

The infrared light source 20 is an infrared light emitting diode. The infrared light source 20 includes a light emitting portion 22 and two wires 24. The light emitting portion 22 emits the infrared light. The wires 24 are electrically connected to the light emitting portion 22 and a power source, such as a battery unit (not shown) equipped within the optical pen 100.

In this embodiment, the converging lens unit 30 includes a converging lens 30. The converging lens 30 is a convex lens with a meniscus shape. The converging lens 30 is positioned along the light path of the infrared light emitted from the infrared light source 20. The converging lens 30 includes an optical portion 32 and a supporting portion 34. The supporting portion 34 surrounds the optical portion 32. The optical portion 32 is configured for converging light. The supporting portion 34 is configured for supporting the converging lens 30 in the receiving space 12. In this embodiment, the supporting portion 34 is ring-shaped.

The optical portion 32 includes a convex surface 32a and a concave surface 32b at opposite sides of the converging lens 30. The convex surface 32a is further away from the infrared light source 20 than the concave surface 32b. The converging lens 30 may be made from glass or plastic.

The tip 40 is substantially a stepped hollow cylinder. The tip 40 includes a receiving end 42 and a handwriting end 44 at opposite sides of the tip 40. The receiving end 42 is received in the receiving space 12. The handwriting end 44 protrudes from the body 10. The tip 40 defines a circular through hole 46 extending from the receiving end 42 to the handwriting end 44. The tip 40 may be attached in the body 10 by adhesive means. The tip 40 is opaque for blocking other undesirable light to improve detectability of the infrared light. It is to be understood that in other alternative embodiment, opaque coats are formed on an inner surface of the tip 40 in the through hole 46 and an outer surface of the tip 40 to block the undesirable light.

In this embodiment, the tip 40 includes an inner step 41 in the through hole 46. A supporting surface 42a is formed on the inner step 41 in the through hole 46 and is configured for mounting the converging lens 30. The through hole 46 includes a first opening 46a at the receiving end 42, and a second opening 46b at the handwriting end 44. A diameter of the first opening 46a is larger than that of the second opening 46b. The supporting portion 34 may be fixedly adhered to the supporting surface 42a so that the converging lens 30 is mounted to the supporting surface 42a. An end surface 44a of the handwriting end 44 is a curved surface. The infrared light source 20 emits the infrared light, and the converging lens 30 converges the infrared light. The converged infrared light travels through the through hole 46 and is emitted from the second opening 46b to a writing area (not shown). An infrared light spot is formed on the writing area accordingly. When the optical pen 100 moves, the infrared light spot on the writing area follows the movement of the optical pen 100 correspondingly.

The fixing member 50 is configured for fixing the infrared light source 20 in the body 10. The fixing member 50 includes a fixing cover 52 and a support 54 fixed to the fixing cover 52. The light emitting portion 22 is fixedly received in the fixing cover 52. The fixing cover 52 defines a light emitting hole 56 aligned with the through hole 46 to allow the infrared light to travel to the through hole 46. The wires 24 extend through the support 54 so that the wires 24 can be protected by the support 54. A material of the fixing member 50 may be plastic. It is to be understood that in other alternative embodiment, the fixing member 50 can be omitted, and the infrared light source 20 is directly attached to the body 10.

The optical pen 100 further includes a switch 16. The switch 16 is arranged at one ends of the body 10 away from the tip 40. The switch 16 is configured for controlling the infrared light source 20 to turn on and turn off.

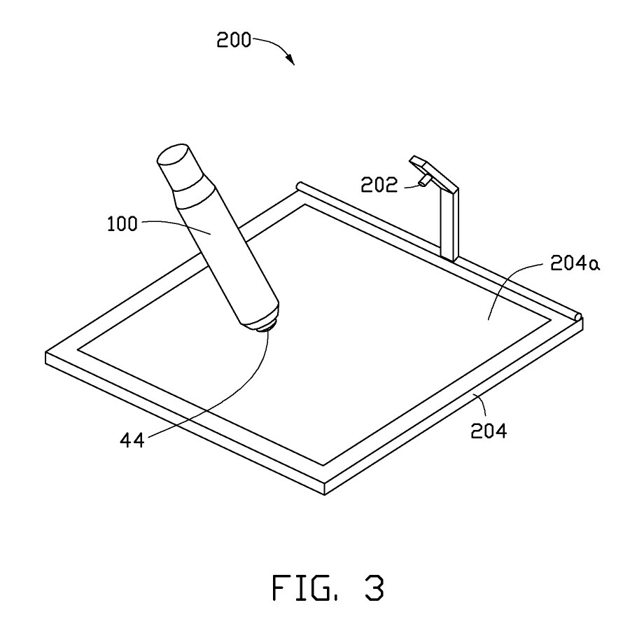

Referring to FIG. 3, an optical touch device 200, according to a second exemplary embodiment, is shown. The optical touch device 200 includes the optical pen 100 of the first exemplary embodiment, an infrared camera module 202 and a handwriting panel 204.

The infrared camera module 202 is positioned at a side of the handwriting panel 204. A field of view of the infrared camera module 202 covers an entire handwriting surface 204a of the handwriting panel 204. The field of view of the infrared camera module 202 is dependant to a wide-angle lens used by the infrared camera module 202 and a distance between the infrared camera module 202 and the handwriting surface 204a.

The infrared camera module 202 is configured for capturing images of a movement track of the infrared light spot projected by the optical pen 100 on the handwriting surface 204a. The captured images of the movement track of the infrared light spot may be transmitted to an information processing apparatus, such as a computer, a communication terminal or a personal digital assist for some applications, such as for inputting information.

Generally, when the handwriting panel 204 is used, the optical pen 100 is tilted relative to the handwriting surface 204a of the handwriting panel 204. Thus, the tip 40 will not block the infrared light spot from projecting on the handwriting panel 204, and the infrared light spot is detectable by the infrared camera module 202.

When in use, the handwriting end 44 contacts the handwriting surface 204a of the handwriting panel 204. The infrared light source 20 emits the infrared light. The infrared light is converged by the optical portion 32 of the converging lens 30 and travels through the through hole 46. Finally, the converged infrared light is projected onto the handwriting surface 204a to form the infrared light spot. When the optical pen 100 moves, the infrared light spot on the handwriting panel 204 follows the movement of the optical pen 100 correspondingly. The infrared camera module 202 captures the images of the movement track of the infrared light spot.

It is to be understood that the handwriting panel 204 of the optical touch device 200 can be omitted. In stead, the optical pen 100 can be used on diffuse-reflection surfaces. The infrared camera module 202 can be fixed to other suitable objects to capture the images of the movement track of the infrared light spot on these surfaces.

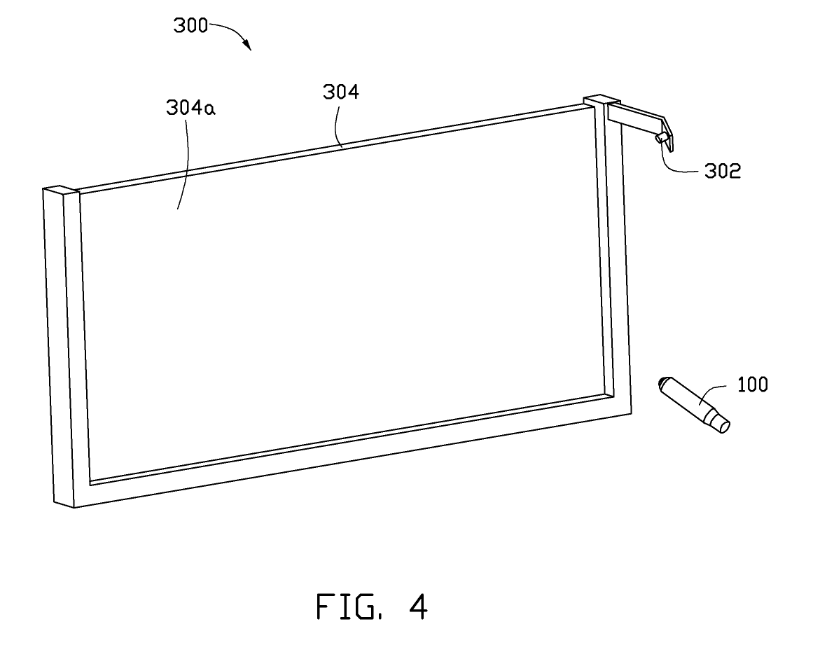

Referring to FIG. 4, an optical touch device 300, according to a third exemplary embodiment, is shown. The optical touch device 300 includes the optical pen 100 of the first exemplary embodiment, an infrared camera module 302 and a display screen 304.

The infrared camera module 302 is positioned at a corner of the display screen 304. A field of view of the infrared camera module 302 covers an entire display surface 304a of the display screen 304. The display screen 304 may be a liquid crystal display or an organic light emitting diode display.

When in use, the optical pen 100 projects the infrared light spot onto the display surface 304a of the display screen 304. The images of the movement track of the infrared light spot are captured by the infrared camera module 302. The captured images of the movement track of the infrared light spot can be processed and used for some applications, such as for inputting information.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An optical pen, comprising:
a body;
an infrared light source received in the body;
a converging lens unit received in the body and positioned along the light path of infrared light emitted from the infrared light source, and configured for converging the infrared light; and
a tip comprising a receiving end and a handwriting end at opposite sides thereof and defining a through hole extending from the receiving end to the handwriting end, the receiving end received in the body and configured for fixing the converging lens unit, the handwriting end protruding from the body and configured for projecting the converged infrared light.

2. The optical pen of claim 1, wherein the body is substantially a hollow cylinder and defines a receiving space therein, the receiving space configured for receiving the infrared light source and the converging lens unit.

3. The optical pen of claim 1, wherein the through hole comprises a first opening at the receiving end and a second opening at the handwriting end.

4. The optical pen of claim 3, wherein the tip comprises an inner step in the through hole and a diameter of the first opening is greater than that of the second opening.

5. The optical pen of claim 4, wherein a supporting surface is formed on the inner step in the through hole and is configured for mounting the converging lens unit.

6. The optical pen of claim 5, wherein the converging lens unit comprises a converging lens, the converging lens comprising an optical portion and a supporting portion surrounding the optical portion, the supporting portion fixedly attached to the supporting surface to fix the converging lens in the body.

7. The optical pen of claim 1, further comprising a fixing member configured for fixing the infrared light source in the body.

8. The optical pen of claim 7, wherein the infrared light source comprises a light emitting portion and two wires, the light emitting portion configured for emitting the infrared light, and the wires electrically connected to the light emitting portion.

9. The optical pen of claim 8, wherein the fixing member comprises a fixing cover and a support fixed to the fixing cover, the fixing cover configured for fixedly receiving the light emitting portion and defining a light emitting hole aligned with the through hole, the wires extending through the support.

10. An optical touch device, comprising:
an optical pen, comprising:
a body;
an infrared light source received in the body;
a converging lens unit received in the body and positioned along the light path of infrared light emitted from the infrared light source, and configured for converging the infrared light; and
a tip comprising a receiving end and a handwriting end at opposite sides thereof and defining a through hole extending from the receiving end to the handwriting end, the receiving end received in the body and configured for fixing the converging lens unit, the handwriting end protruding from the body and configured for projecting the converged infrared light to form an infrared light spot; and
an infrared camera module configured for capturing images of a movement track of the infrared light spot.

11. The optical touch device of claim 10, further comprising a handwriting panel for allowing the infrared light spot to project onto a handwriting surface thereof, the infrared camera module positioned at a side of the handwriting panel.

12. The optical touch device of claim 11, wherein a field of view of the infrared camera module covers the entire handwriting surface of the handwriting panel.

13. The optical touch device of claim 10, further comprising a display screen for allowing the infrared light spot to project onto a display surface thereof, the infrared camera module positioned at a corner of the display screen.

14. The optical touch device of claim 13, wherein a field of view of the infrared camera module covers the entire display surface of the display screen.
